(19) United States
(12) Patent Application Publication
(10) Pub. No.: US 2015/0353005 A1
(43) Pub. Date: Dec. 10, 2015

(54) THIN OVERHEAD CONSOLE

(71) Applicant: Yanfeng Global Automotive Interior Systems Co., Ltd, Plymouth, MI (US)

(72) Inventors: Thomas Hodgson, Holland, MI (US); Ame Dassen, Holland, MI (US); Jonathan M. Frens, Hudsonville, MI (US); Scott R. Meyers, Holland, MI (US); Michael Catlin, Holland, MI (US); Nicholas T. Moelker, Allendale, MI (US); Kyle Beeck, Grand Heven, MI (US)

(21) Appl. No.: 14/760,469

(22) PCT Filed: Jan. 10, 2014
(86) PCT No.: PCT/US2014/010966

§ 371 Date: Jul. 10, 2015

Related U.S. Application Data
(60) Provisional application No. 61/751,531, filed on Jan. 11, 2013.

(51) Int. Cl. B60Q 3/02; G06F 3/01; B60R 7/04

(52) U.S. Cl. CPC B60Q 3/0279; B60R 7/04; B60Q 3/0203; B60Q 3/0296; G06F 3/016

(57) ABSTRACT

An overhead console for a vehicle having a lighting assembly. The lighting assembly may include multiple light sources configured to emit light toward a show surface of the overhead console. Each light source may include a light-emitting diode. The overhead console may also include a capacitive sensing input device, a sunroof control device, a haptic feedback device, a directional lighting device, and so forth. The overhead console has a thickness of less than or equal to approximately 15 millimeters.

### CROSS REFERENCE TO RELATED APPLICATION

This application claims priority from and the benefit of U.S. Provisional Application Ser. No. 61/751,530, entitled “A THIN OVERHEAD CONSOLE FOR A VEHICLE”, filed Jan. 11, 2013, which is hereby incorporated by reference in its entirety.

### BACKGROUND

The invention relates generally to motor vehicles, and more particularly, to a thin overhead console for a vehicle.

Vehicles typically include an overhead console to perform various functions, such as to illuminate various regions of a vehicle interior. For example, certain vehicles include one or more overhead lights in an overhead console to illuminate driver and/or passenger seating areas. Furthermore, an overhead console may include electronic components such as switches, indicators, controls, and so forth. For example, an overhead console may include switches for operating a sunroof and/or controls for operating a garage door. Unfortunately, overhead consoles may occupy a large amount of space within the vehicle interior, thereby limiting cargo space and/or occupant headroom.

### BRIEF DESCRIPTION OF THE INVENTION

The present invention relates to an overhead console for a vehicle having a lighting assembly. The overhead console has a thickness of less than or equal to approximately 15 millimeters.

The present invention also relates to a lighting assembly for a vehicle having multiple light sources, a decorative surface, and a light guide. The light guide includes multiple reflective surfaces configured to direct light emitted from the light sources toward the decorative surface. The reflective surfaces are configured to combine the light emitted from the light sources inside the light guide, and to direct the combined light onto the decorative surface to provide a substantially uniform illumination of the decorative surface.

The present invention further relates to a lighting assembly for a vehicle including a decorative surface and a light source configured to direct light toward the decorative surface. The light source is concealed behind a show surface. The lighting assembly has a thickness of less than or equal to approximately 15 millimeters.

The present invention also relates to a method of directing light in a lighting assembly including reflecting light from multiple light sources onto a decorative surface. The light sources are concealed behind a show surface. Moreover, the reflected light is a combination of light emitted from each of the light sources, and the reflective surfaces are configured to direct the combination of light onto the decorative surface to provide a substantially uniform illumination of the decorative surface.

The present invention relates to a lighting assembly for a vehicle including a light source and an arcuate reflective surface disposed at least partially over the light source. The arcuate reflective surface is configured to reflect light emitted from the light source. The lighting assembly has a thickness of less than or equal to approximately 15 millimeters.

The present invention also relates to a lighting assembly for a vehicle including a light-emitting diode configured to direct a beam of light toward a vehicle interior. The lighting assembly also includes an arcuate reflective surface disposed in a path of the beam between the light-emitting diode and the vehicle interior. The arcuate reflective surface is configured to reflect light emitted from the light-emitting diode.

The present invention further relates to a lighting assembly for a vehicle including a light source and a show surface disposed over the light source. A distance between the light source and the show surface is less than or equal to approximately 15 millimeters. The lighting assembly also includes multiple reflectors configured to direct light emitted from the light source toward the show surface. The reflectors are configured to block a direct path between the light emitted from the light source and the show surface.

The present invention relates to an overhead console for a vehicle including a show surface configured to provide tactile feedback using vibrations. The overhead console also includes a support structure. The overhead console also includes a mounting assembly configured to couple the show surface to the support structure. The mounting assembly includes a damper to block at least a portion of the vibrations from the show surface to the support structure.

The present invention also relates to a console for a vehicle including a capacitive sensing input device configured to receive a slide and release input to control motion of a movable panel of the vehicle.

### DRAWINGS

FIG. 1 is a perspective view of an exemplary vehicle that may include a thin overhead console.

FIG. 2 is a top perspective view of an embodiment of a thin overhead console.

FIG. 3 is a bottom perspective view of an embodiment of a thin overhead console.

FIG. 4 is a cross-sectional view of an embodiment of a mounting assembly for coupling a show surface of a thin overhead console to a support structure of the thin overhead console.

FIG. 5 is an exploded view of the mounting assembly of FIG. 4.

FIG. 6 is an exploded view of an embodiment of a mounting assembly for coupling a show surface of a thin overhead console to a support structure of the thin overhead console.

FIG. 7 is a perspective view of an embodiment of a capacitive sensing input device of a thin overhead console.

FIG. 8 is a cross-sectional view of an embodiment of a lighting assembly for illuminating a lighting feature of a thin overhead console.

FIG. 9 is a cross-sectional view of an embodiment of a lighting assembly for illuminating a decorative surface of a thin overhead console.

FIG. 10 is a cross-sectional view of an embodiment of a lighting assembly for illuminating an interior portion of a vehicle.

### DETAILED DESCRIPTION

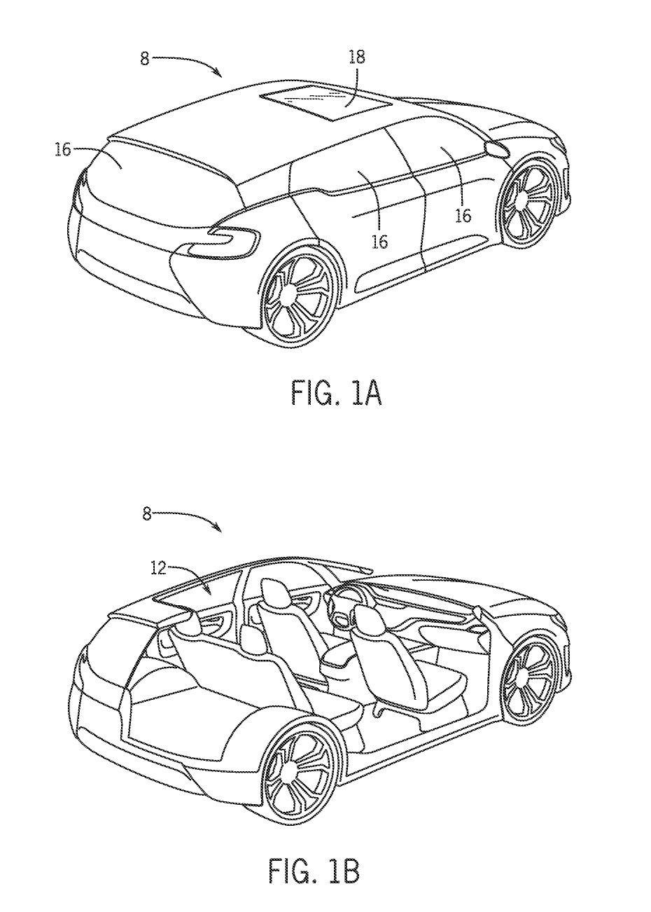

FIG. 1 is a perspective view of an exemplary vehicle 10 that may include an thin overhead console, such as an overhead console having a thickness of less than or equal to approximately 15 millimeters. The vehicle 10, in this case a car, includes an interior 12 and an exterior 14. The vehicle 10 also includes windows 16 and a sunroof 18. The thin overhead console may be located in the interior 12 of the vehicle 10 adjacent to the sunroof 18. The thin overhead console may be configured to control operation of the sunroof 18. Furthermore, in certain embodiments, the thin overhead console may be configured to control operation of one or more of the windows 16. In other embodiments, a console with similar features to the thin overhead console may be used to control operation of the windows 16. Moreover, the thin overhead console may include one or more lighting assemblies for illuminating decorative surfaces of the thin overhead console and/or a passenger area of the vehicle 10. In certain embodiments, the thin overhead console may include controls for operating a garage door, placing phone calls, and so forth. The thin overhead console may also include one or more speakers. Furthermore, the thin overhead console may be manufactured to occupy a small amount of cargo space. For example, the thin overhead console may have a thickness of less than or equal to approximately 15 millimeters, thereby increasing the amount of cargo space within the vehicle 10 without reducing features of the overhead console.

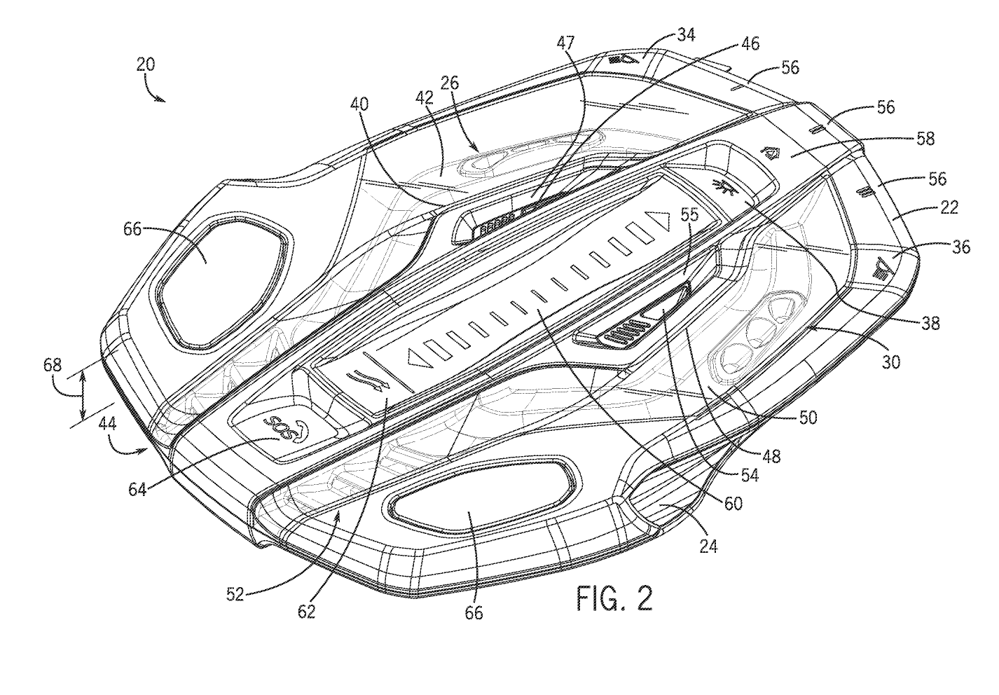

FIG. 2 is a top perspective view of an embodiment of a thin overhead console 20. The thin overhead console 20 includes a show surface 22 coupled to a support structure 24. The show surface 22 is the portion of the thin overhead console 20 that is visible and operable by an operator. The show surface 22 includes various lighting assemblies, switches, and other features. Specifically, the show surface 22 includes a first task light 26 having multiple light sources 28 to provide directional lighting, and a second task light 30 having multiple light sources 32 to provide directional lighting. As may be appreciated, the first task light 26 may be positioned on a passenger side of the vehicle 10 to illuminate the passenger side of the vehicle 10, and the second task light 30 may be positioned on a driver side of the vehicle 10 to illuminate the driver side of the vehicle 10. Each of the light sources 28 and 32 may include one or more light-emitting diodes. A first task light switch 34 is used to operate the first task light 26, while a second task light switch 36 is used to operate the second task light 30. Moreover, a switch 38 may operate the first task light 26 and the second task light 30 together.

One or more light sources 40 are configured to emit light to illuminate a passenger side decorative surface 42. Furthermore, light sources 44 are configured to illuminate an end portion of the thin overhead console 20, and light sources 46 are also configured to illuminate a decorative surface 47. Moreover, one or more light sources 48 are configured to emit light to illuminate a driver side decorative surface 50. Furthermore, light sources 52 are configured to illuminate an end portion of the thin overhead console 20, and light sources 54 are also configured to illuminate a decorative surface 55. Each of the light sources 40, 44, 46, 48, 52, and 54 may include one or more light-emitting diodes.

The thin overhead console 20 includes switches 56 that may be programmed to operate a garage door. Furthermore, upon selection of one or more of the switches 56, an icon 58 may be illuminated. The thin overhead console 20 also includes a capacitive sensing input device 60 configured to receive an input, such as a touch from a finger, to control operation of the sunroof 18. The capacitive sensing input device 60 is configured to receive a slide and release input to control the sunroof 18 to a fully opened position with a slide and relase in a first direction, and to control the sunroof 18 to a fully closed position with a slide and release in a second direction opposite the first direction. As may be appreciated, in certain embodiments, the capacitive sensing input device 60 may be used to operate windows 16 of the vehicle 10. The thin overhead console 20 also includes a tilt control button 62 for controlling a tilt angle of the sunroof 18.

The thin overhead console 20 includes a switch 64 used to place a phone call, such as for emergency conditions. Moreover, the thin overhead console 20 includes speakers 66 to provide audio feedback to an operator. As illustrated, the thin overhead console 20 has a thickness 68. The thickness 68 corresponds to the height of the thin overhead console 20, which includes the components as illustrated, including the show surface 22, and the support structure 24 used to support the show surface 22. In some embodiments, the thin overhead console 20 may have a thickness 68 of less than or equal to approximately 15 millimeters. In other embodiments, the thin overhead console 20 may have a thickness 68 of 5 to 10 millimeters, 10 to 20 millimeters, or 15 to 30 millimeters. Accordingly, the thin overhead console 20 may occupy a small amount of the space within the interior 12 of the vehicle 10. As such, the thin overhead console 20 may minimally interfere with operation of the vehicle 10, and may provide useful functions to an operator of the vehicle 10.

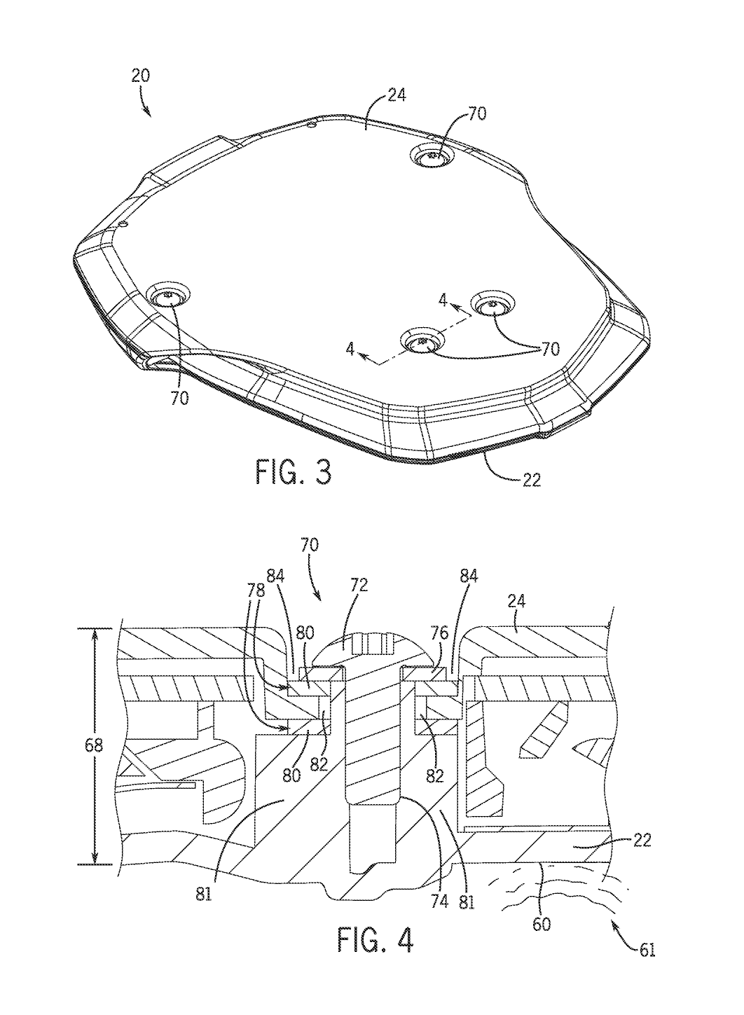

FIG. 3 is a bottom perspective view of an embodiment of the thin overhead console 20. As illustrated, the support structure 24 is coupled to the show surface 22 and provides support to the show surface 22. The support structure 24 is coupled to the show surface 22 using mounting assemblies 70. As may be appreciated, the thin overhead console 20 may be configured to provide haptic (e.g., vibration, tactile) feedback to an operator of the vehicle 10. For example, after an operator presses one of the switches on the thin overhead console 20, the thin overhead console 20 may vibrate to provide the operator with feedback indicating that the switch has been pressed. To enhance longevity of the thin overhead console 20, the mounting assemblies 70 include one or more dampers configured to block at least a portion of the vibrations from the show surface 22 to the support structure 24. Accordingly, the show surface 22 may vibrate, and the support structure 24 may be at least partially isolated from the vibrations.

FIG. 4 is a cross-sectional view of an embodiment of the mounting assembly 70 for coupling the show surface 22 of the thin overhead console 20 to the support structure 24 of the thin overhead console 20. The mounting assembly 70 includes a fastener 72 (e.g., screw) coupled to a boss 74 extending from the show surface 22. Moreover, the mounting assembly 70 includes a washer 76 disposed between the fastener 72 and the boss 74. The washer 76 may be a metallic washer, or may be formed from any suitable material. The mounting assembly 70 also includes a compressible material 78 disposed between the washer 76 and the support structure 24 to absorb vibrations of the show surface 22. The compressible material 78 in the present embodiment includes a pair of compressible washers 80, but may be any suitable compressible material. For example, the compressible material 78 may include a polymeric material, rubber, silicon, and so forth. An upper compressible washer 80 is disposed between the washer 76 the support structure 24, and a lower compressible washer 80 is disposed between the support structure 24 and an extension 81 that extends outwardly from the boss 74. The compressible material 78 enables the show surface 22 to vibrate, yet blocks a portion of the vibrations from transferring to the support structure 24. Gaps 82 and 84 enable isolation between the show surface 22 and the support structure 24. Accordingly, the show surface 22 and the support structure 24 each contact the compressible material 78, but the show surface 22 and the support structure 24 do not directly contact one another.

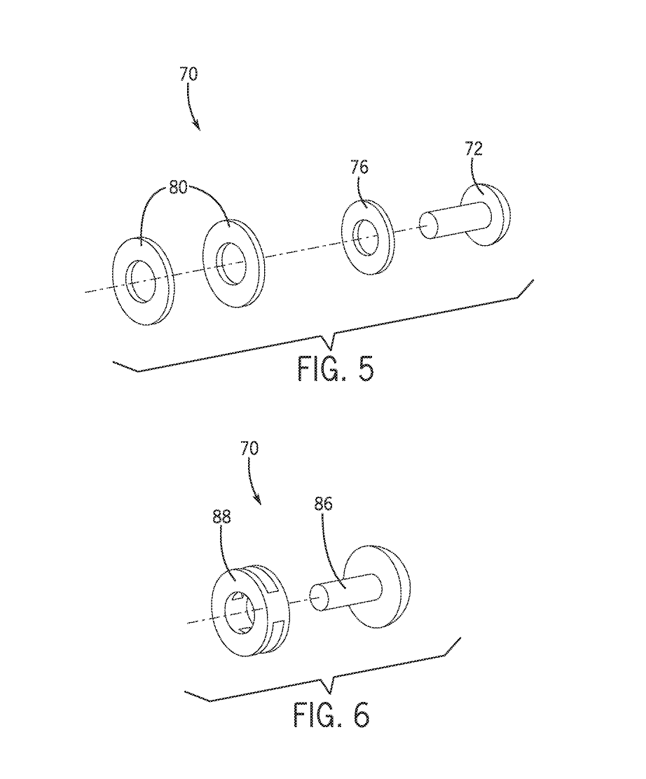

FIG. 5 is an exploded view of the mounting assembly 70 of FIG. 4. As illustrated, the fastener 72 is inserted through the washer 76, and through the compressible washers 80. However, the compressible material 78 may be any suitable device. For example, FIG. 6 is an exploded view of another embodiment of the mounting assembly 70 for coupling the show surface 22 to the support structure 24. In FIG. 6, a fastener 86 is used in place of the fastener 72 and the washer 76. Moreover, a grommet 88 is used in place of the compressible washers 80. In other embodiments, any suitable combination of a fastener and a compressible material 78 may be used. Accordingly, the mounting assembly 70 facilitates mounting the show surface 22 to the support structure 24, while blocking vibrations of the show surface 22 from passing to the support structure 24.

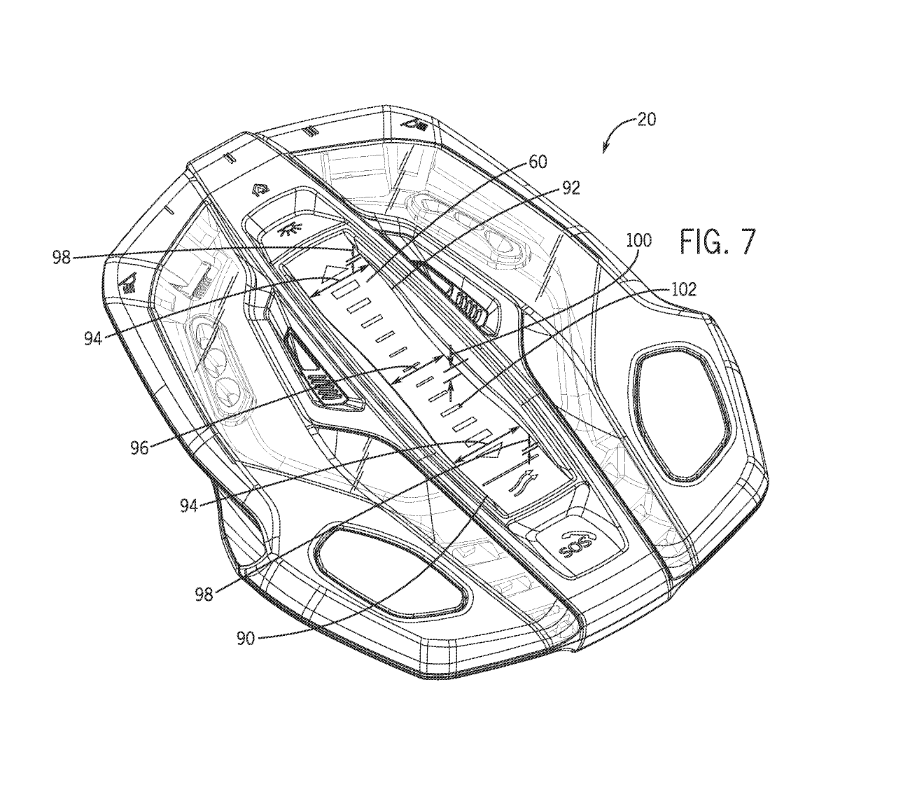

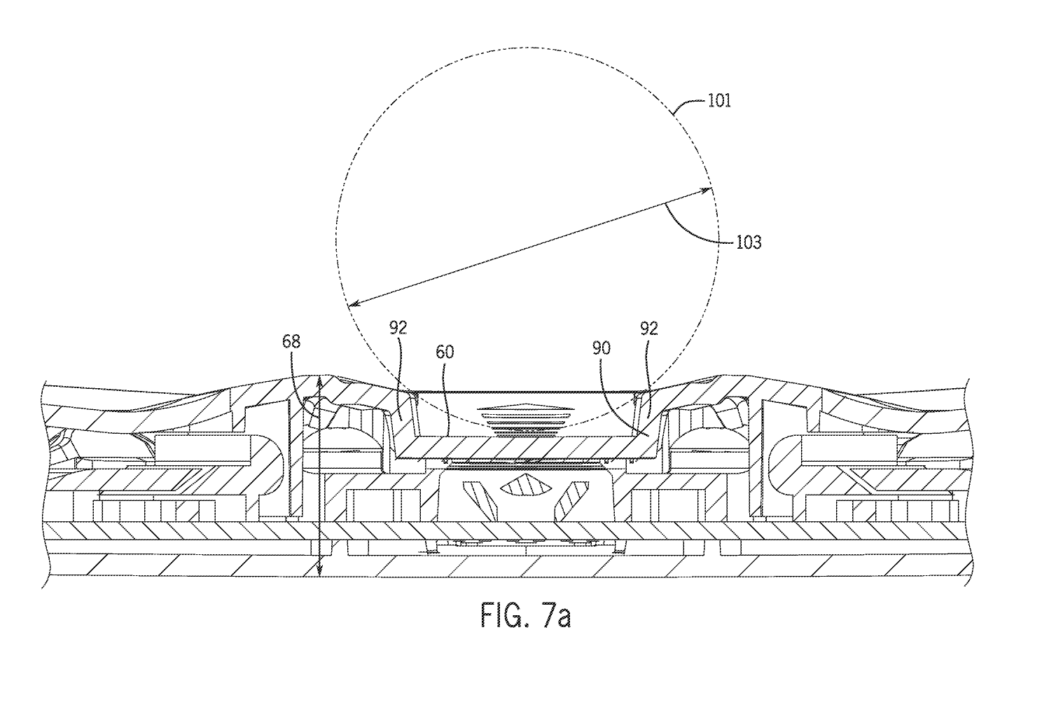

FIG. 7 is a perspective view of an embodiment of the capacitive sensing input device 60 of the thin overhead console 20. The capacitive sensing input device 60 may include multiple sensors configured to detect contact with the capacitive sensing input device 60 at various locations along the capacitive sensing input device 60. In some embodiments, the capacitive sensing input device 60 may use any suitable technology to detect contact (e.g., a touch), such as capacitive technology, inductive technology, infrared technology, optical technology, and so forth. In certain embodiments, the capacitive sensing input device 60 is used to control the sunroof 18. For example, an operator may touch a portion of the capacitive sensing input device 60 using a finger to move the sunroof 18.

In some embodiments, the sunroof 18 may be controlled by pressing and holding a finger on the capacitive sensing input device 60. Furthermore, the operator may slide and release a finger from one end of the capacitive sensing input device 60 toward the opposite end of the capacitive sensing input device 60, thereby providing a slide and release input to the capacitive sensing input device 60 to fully open (e.g., when the slide and release is in a first direction), to fully close (e.g., when the slide and release is in a second direction, opposite the first direction), to tilt open, or to tilt closed the sunroof 18. In some embodiments, the sunroof 18 may be transitioned to an opened or closed position using a slide and hold motion, wherein the capacitive sensing input device 60 is slid, and a finger is held against the capacitive sensing input device 60 at the end of the slide. Furthermore, the sunroof 18 may be tilted open, tilted closed, opened, and/or closed using one or more taps (e.g., single tapping, double tapping, triple tapping, etc.).

Moreover, in some embodiments, an operator may slide two fingers together (e.g., pinch) to close the sunroof 18, and may slide two fingers apart to open the sunroof 18, or vice versa. The capacitive sensing input device 60 may include certain portions used to control tilting and certain portions used to control opening/closing of the sunroof 18. In certain embodiments, the operator may slide and release a finger from one end of the capacitive sensing input device 60 toward the opposite end of the capacitive sensing input device 60 to fully open or to fully close the windows 16, or any suitable movable panel of the vehicle 10. In other embodiments, the capacitive sensing input device 60 may be used for controlling doors of the vehicle 10, such as for locking and/or unlocking doors.

A housing 90 of the capacitive sensing input device 60 includes walls 92 that surround the capacitive sensing input device 60 and that block certain objects from touching the capacitive sensing input device 60. For example, a width 94 of the capacitive sensing input device 60 between the walls 92 at ends of the capacitive sensing input device 60 is greater than a width 96 of the capacitive sensing input device 60 between the walls 92 at a central portion of the capacitive sensing input device 60. Furthermore, a height 98 of the walls 92 at the ends of the capacitive sensing input device 60 is less than a height 100 of the walls 92 at the central portion of the capacitive sensing input device 60. Accordingly, an object that may touch the capacitive sensing input device 60 at the ends of the capacitive sensing input device 60 may not touch the capacitive sensing input device 60 at the central portion of the capacitive sensing input device 60. For example, in certain embodiments, a spherical object having a diameter greater than or equal to approximately 40 millimeters may be blocked from contacting the capacitive sensing input device 60 at the ends of the capacitive sensing input device 60 and/or at the central portion of the capacitive sensing input device 60. Therefore, such a spherical object may not be able to touch the capacitive sensing input device 60 with a swiping motion that extends from one of the ends of the capacitive sensing input device 60 to the central portion of the capacitive sensing input device 60 to provide a slide and release input. In some embodiments, a spherical object having a diameter between approximately 30-40 millimeters, 35-45 millimeters, or 40-50 millimeters may be blocked from contacting the capacitive sensing input device 60 at the ends of the capacitive sensing input device 60 and/or at the central portion of the capacitive sensing input device 60.

The capacitive sensing input device 60 includes lighting features 102 disposed on or embedded within or behind the capacitive sensing input device 60. The lighting features 102 may indicate a direction of movement of the sunroof 18, or some other status, such as a readiness state, a close proximity of an operator relative to the capacitive sensing input device 60 (e.g., the lighting features 102 may illuminate when a finger approaches the capacitive sensing input device 60), and so forth. The lighting features 102 may be a single color, or multiple colors. In certain embodiments, the thin overhead console 20 may be configured to provide audible and/or haptic feedback when the capacitive sensing input device 60 is used and/or activated. As described herein, the capacitive sensing input device 60 enables the sunroof 18 to be easily controlled by an operator.

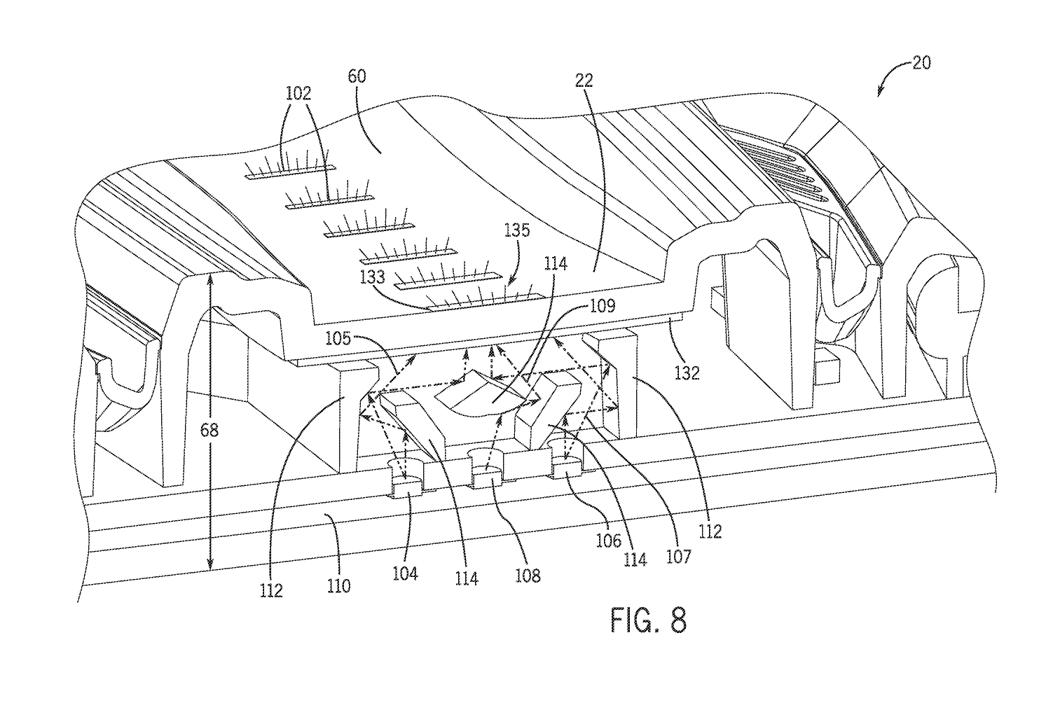

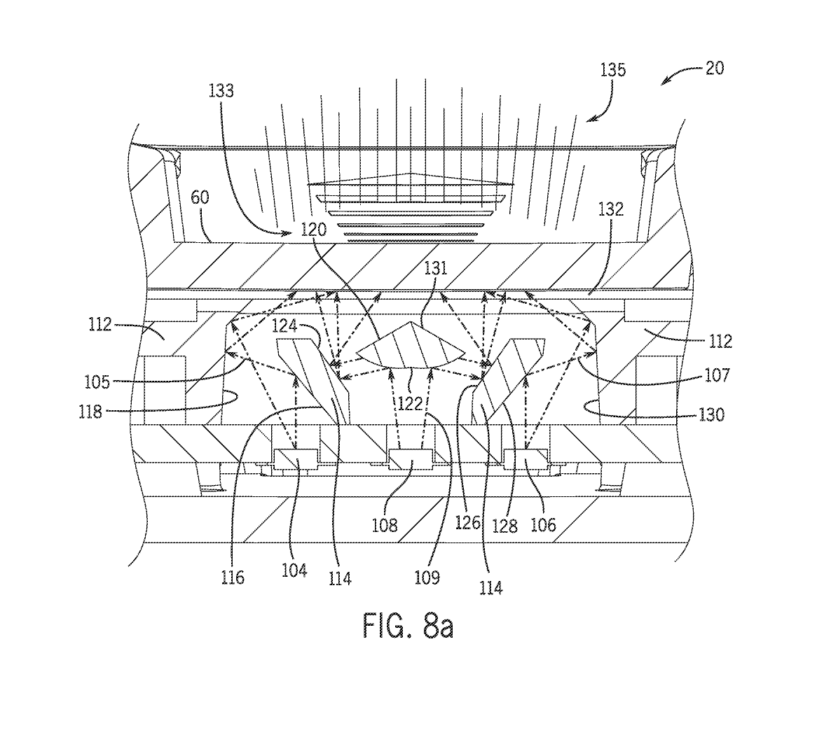

FIG. 8 is a cross-sectional view of an embodiment of a lighting assembly for illuminating a lighting feature 102 of the thin overhead console 20. Each lighting feature 102 includes light sources 104, 106, and 108. In certain embodiments, the light sources 104, 106, and 108 may be light-emitting diodes. Moreover, the light sources 104, 106, and 108 may provide illumination of different colors. For example, in one embodiment, the light sources 104 and 106 provide illumination of a first color, and the light source 108 provides illumination of a second color. The light sources 104, 106, and 108 are mounted to a printed circuit board (PCB) 110 that provides power to the light sources 104, 106, and 108. In certain embodiment, light emitted from light sources 104, 106, and 108 provides a substantially uniform illumination if the illuminated object is approximately 30 millimeters from the light sources 104, 106, and 108. Because the thickness 68 of the thin overhead console 20 is less than or equal to 15 millimeters, various reflective surfaces are used to block a direct path of light from the light sources 104, 106, and 108 to the lighting features 102, and to increase the distance traveled by light emitted from the light sources 104, 106, and 108, thereby scattering the light and enabling a substantially uniform illumination of the lighting features 102.

In the illustrated embodiment, reflective walls 112, and reflective devices 114 reflect light emitted from the light sources 104, 106, and 108 to increase the distance traveled by the light. For example, light emitted from the light source 104 may be reflected off reflective surfaces 116, 118, and 120 as the light travels from the light source 104 to the lighting feature 102. Furthermore, light emitted from the light source 108 may be reflected off reflective surfaces 122, 124, and 126 as the light travels from the light source 108 to the lighting feature 102. Moreover, light emitted from the light source 106 may be reflected off reflective surfaces 128, 130, and 131 as the light travels from the light source 106 to the lighting feature 102. Accordingly, the reflective walls 112 and the reflective devices 114 block a direct path of light from the light sources 104, 106, and 108 to the lighting features 102, and increase the distance traveled by light emitted from the light sources 104, 106, and 108. As such, the light emitted from the light sources 104, 106, and 108 is scattered, thereby enabling a more uniform illumination of the lighting features 102.

As may be appreciated, one or more of the light sources 104, 106, and 108 may emit light at the same time. For example, in one embodiment, light sources 104 and 106 may emit light together and/or at a different time from light source 108. Moreover, the light sources 104, 106, and 108 may emit light of one color or multiple colors. In some embodiments, more than one light source 104, 106, and 108 may emit different colored light together to facilitate mixing of different colors. The thin overhead console 20 includes a diffuser layer 132 disposed between the reflective surfaces and the show surface 22 to facilitate diffusing light emitted by the light sources 104, 106, and 108. In certain embodiments, the thin overhead console 20 may diffuse light without the diffuser layer 132. Moreover, the show surface 22 includes a light-transmissive portion 133 to enable light emitted by the light sources 104, 106, and 108 to be transmitted therethrough. The light-transmissive portion 133 may have any suitable shape or icon, such as the illustrated rectangular shape.

FIG. 9 is a cross-sectional view of an embodiment of a lighting assembly 134 for illuminating a decorative surface of the thin overhead console 20. The lighting assembly 134 includes light sources 136 disposed along a length of the thin overhead console 20. In certain embodiments, the light sources 136 may be light-emitting diodes. The lighting assembly 134 includes a light guide 138 configured to receive light emitted from the light sources 136, to combine the light from the light sources 136, and to direct the combined light toward a decorative surface 140. In the illustrated embodiment, a light-transmissive portion 142 of the show surface 22 is disposed over the decorative surface 140 and enables viewing of the decorative surface 140. In certain embodiments, the show surface 22 may not include the light-transmissive portion 142, such that the decorative surface 140 is directly viewable. Moreover, an opaque portion 144 of the show surface 22 blocks viewing of the light guide 138, such that the light guide 138 is concealed behind the opaque portion 144.

The light guide 138 includes multiple reflective surfaces configured to direct the light emitted from the light sources 136 and to combine the light. As illustrated, the light guide 138 includes a first reflective surface 146, a second reflective surface 148, and a third reflective surface 150. The first reflective surface 146 is angled with a substantially uniform slope such that the first reflective surface 146 reflects most of the light emitted from the light sources 136 toward the second reflective surface 148. The second reflective surface 148 is rounded and reflects the light from the first reflective surface 146 toward the third reflective surface 150. The third reflective surface 150 is also rounded and reflects the light from the light second reflective surface 148 toward the decorative surface 140. As may be appreciated, in certain embodiments, the first reflective surface 146 may be rounded or may have any suitable shape. Furthermore, the second and third reflective surfaces 148 and 150 may be flat, angled, ramped, or have any other suitable shape. The reflective surfaces 146, 148, and 150 combine the light from multiple light sources 136 to form a substantially uniform illumination on the decorative surface 140. This occurs within the thin overhead console 20 having a thickness 68 less than or equal to 15 millimeters. In certain embodiments, the light sources 136 may include light sources having different colors that are merged together to illuminate the decorative surface 140. In other embodiments, different portions of the decorative surface 140 may be illuminated with different colors.

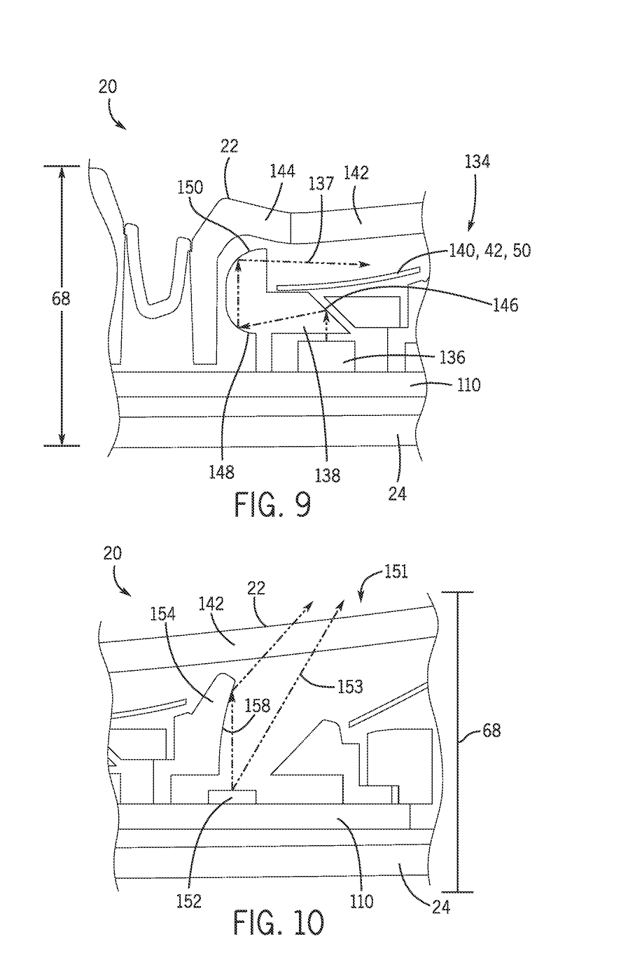

FIG. 10 is a cross-sectional view of an embodiment of a lighting assembly 151 for illuminating an interior portion of the vehicle 10, such as a driver and/or passenger side of the vehicle 10. The lighting assembly 151 may be part of the first and/or second task lights 26 and 30. The lighting assembly 151 includes a light source 152, such as a light-emitting diode, or another suitable lighting device. Light is emitted from the light source 152 toward a directional control device 154. The direction control device 154 reflects a substantial portion of light emitted from the light source 152 toward the light-transmissive portion 142 of the show surface 22. The directional control device 154 includes an arcuate reflective surface 158 configured to direct the light toward the light-transmissive portion 142. In certain embodiments, the light-transmissive portion 142 includes a textured surface configured to diffuse light transmitted through the light-transmissive portion 142. As illustrated, the arcuate reflective surface 158 is disposed at least partially over the light source 152.

In certain embodiments, the arcuate reflective surface 158 includes a substantially parabolic shape. Moreover, as may be appreciated, the shape of the arcuate reflective surface 158 may be selected based on a type of the light source 152. Furthermore, the shape of the arcuate reflective surface 158 is selected to reflect a substantial portion of the light emitted from the light source 152. As may be appreciated, the arcuate reflective surface 158 may have any suitable finish disposed thereon. Moreover, the shape of the arcuate reflective surface 158 may be selected based at least partially on the type of finish. As illustrated, the lighting assembly 151 is formed within the thin overhead console 20 having a thickness of less then or equal to 15 millimeters. As discussed above, the thin overhead console 20 may be manufactured to occupy a small amount of cargo space, thereby increasing the amount of cargo, passenger, and/or occupant space available for use by occupants without a loss of features.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1-7. (canceled)

8. An overhead console for a vehicle comprising:
a lighting assembly having a plurality of reflective surfaces configured to direct light emitted from a plurality of light sources toward a visible exterior of the overhead console wherein the plurality of reflective surfaces is configured to combine and diffuse the light emitted from the plurality of light sources inside the lighting assembly and to direct the combined and diffused light onto the visible exterior to provide a substantially uniform illumination of the visible exterior;
wherein the lighting assembly has a thickness of less than or equal to approximately 15 millimeters.

9. (canceled)

10. The overhead console of claim 8 comprising the plurality of light sources wherein each light source is positioned behind the visible exterior.

11-12. (canceled)

13. The overhead console of claim 8 wherein the plurality of reflective surfaces comprises a first reflective surface, a second reflective surface, and a third reflective surface, and the first reflective surface is angled to direct at least a portion of the light emitted from the plurality of light sources toward the visible exterior.

14. The overhead console of claim 13 wherein the second reflective surface and the third reflective surface are each rounded.

15. The overhead console of claim 8 comprising an opaque portion of the visible exterior configured to conceal the lighting assembly.

16-35. (canceled)

36. An overhead console for a vehicle comprising:
a switch assembly comprising an element configured to provide haptic feedback, an isolator, and a support structure wherein the isolator is configured to block at least a portion of the haptic feedback from being transferred to the support structure to enhance output of the haptic feedback provided by the element.

37-38. (canceled)

39. The overhead console of claim 36 wherein the isolator comprises a compressible material configured to abut the element and the support structure, and to absorb at least a portion of the haptic feedback.

40. The overhead console of claim 39 wherein the compressible material comprises at least one compressible washer.

41. The overhead console of claim 40 wherein the at least one compressible washer comprises a silicon washer.

42. The overhead console of claim 39 wherein the compressible material comprises a grommet

43. A console for a vehicle comprising:
a switch assembly; and
a housing configured to house the switch assembly, wherein the housing is configured to block a spherical object having a diameter greater than or equal to approximately 40 millimeters from providing input to the switch assembly;
wherein the console has a thickness of less than or equal to approximately 15 millimeters.

44-48. (canceled)

49. The console of claim 43 wherein the housing comprises a first pair of walls adjacent to a first portion of the switch assembly having a first width, and a second pair of walls adjacent to a second portion of the switch assembly having a second width less than the first width.

50. The console of claim 43 wherein the housing comprises a first pair of walls adjacent to a first portion of the switch assembly having a first depth, and a second pair of walls adjacent to a second portion of the switch assembly having a second depth less than the first depth.

51. The console of claim 43 comprising a plurality of lighting features disposed on or embedded within or behind the switch assembly wherein the plurality of lighting features is configured to be illuminated based on input to the switch assembly.

52. The console of claim 43 wherein the console comprises an overhead console.

53. The console of claim 43 wherein the switch assembly comprises a capacitive sensing input device configured to receive a slide and release input, and the housing is configured to block the spherical object from providing the slide and release input to the capacitive sensing input device.

54. The overhead console of claim 8 comprising a diffuser disposed between the plurality of reflectors and the visible exterior.

55. The overhead console of claim 36 wherein the overhead console has a thickness of less than or equal to approximately 15 millimeters.

56. The overhead console of claim 36 wherein the switch assembly comprises a mounting assembly configured to couple the element to the support structure, and the mounting assembly comprises the isolator.

57. The overhead console of claim 36 wherein the haptic feedback comprises vibrations, and the isolator is configured to block at least a portion of the vibrations from the element to the support structures such that the support structure is at least partially isolated from the vibrations.

58. A console for a vehicle comprising:
a lighting assembly comprising a curved reflective surface configured to be disposed at least partially over a light source, wherein the curved reflective surface is configured to reflect light emitted from the light source, and the lighting assembly has a thickness of less than or equal to approximately 15 millimeters.

59. The console of claim 58 wherein the curved reflective surface comprises a substantially parabolic shape.

60. The console of claim 58 wherein a shape of the curved reflective surface is selected based on a type of light source.

61. The console of claim 58 comprising a visible exterior having a light-transmissive portion at least partially disposed over the curved reflective surface wherein the curved reflective surface is configured to direct light toward the light-transmissive portion.

62. The console of claim 61 wherein the light-transmissive portion comprises a textured surface configured to diffuse light transmitted through the light-transmissive portion.
